(19) United States
(12) Patent Application Publication
(10) Pub. No.: US 2008/0243923 A1
(43) Pub. Date: Oct. 2, 2008

(54) System and method for facilitating impulse content purchases

(76) Inventors: Gadi Mazor, Ramat Efal (IL); Ron Maor, London (GB)

Correspondence Address: PILLSBURY WINTHROP SHAW PITTMAN, LLP, P.O. BOX 10500, MCLEAN, VA, 22102, US

(21) Appl. No.: 11/727,285

(22) Filed: Mar. 26, 2007

(51) Int. Cl. G06Q 30/00; G06F 17/30

(52) U.S. Cl. 707/104.1; 705/27

(57) ABSTRACT

A system and method for identifying and facilitating impulse interactions with music, songs, advertisements, or other content are provided. The system and method may enable impulse purchases of music, or impulse reactions to advertising, or other interactions with various types of content. Impulse content purchases may be facilitated by collecting information about content played over a communication medium. The collected information may be stored in a data repository, such that content requested by a user may be identified. Accordingly, information about the identified content and/or at least one option for purchasing the identified content may be provided to the user, effectively creating an anytime, anywhere virtual point-of-sale.

### FIELD OF THE INVENTION

The invention relates to a system and method for identifying and facilitating impulse purchases of content, effectively creating an anytime, anywhere virtual point-of-sale.

### BACKGROUND OF THE INVENTION

People like to listen to music in many different settings. For example, people may listen to the radio while driving their cars, or people may listen to streaming music over the Internet or other networks, or many other variants are possible. At times, a listener may hear a song they like, and may want to purchase the song (e.g., to download the song to a portable music player, such as an Apple iPod™). However, sometimes the listener may not know the name of the song, or sometimes the user may know the song but later forget that they wanted to purchase the song, or many other situations may arise that interfere with purchasing the song.

In such cases, record labels, distributors, artists, and/or others may lose out on potential sales. Moreover, the listener ends up not having purchased music that they like, even though they may intend and desire to make the purchase.

Existing systems for identifying songs suffer from various drawbacks. For example, existing systems do not enable the impulse purchase of a song once identified. Existing systems suffer from these and other problems.

### SUMMARY OF THE INVENTION

Various aspects and implementations of the invention may address these and other drawbacks of existing systems. For example, the invention may be used to identify and facilitating the impulse purchase of content (e.g., music, videos, etc.) through a virtual point-of-sale mechanism. Furthermore, the invention may also be used to provide advertisements to users, and to enable or otherwise facilitate impulse interaction with advertisements.

According to various aspect of the invention, a service system may monitor, receive, or otherwise acquire information about, content played over a communication mechanism (e.g., songs played on a radio). Further, the service system may receive information about advertisements distributed over the communication mechanism. The service system may create a database of the acquired information, including information about the received content and the received advertisements, among other things. Upon receiving a request for content from a user (e.g., via a client communication device), the service system may identify the requested content and provide information to the user relating to the identified content. Further, the service system may provide information relating to various options for the user to purchase, or otherwise acquire, the identified content. Moreover, the service system may provide information to a user about advertisements played over the communication mechanism (e.g., tag lines, logos, available actions, etc.). The user may subsequently interact with the provided advertisement using any appropriate technique (e.g., a client browser associated with a client device or otherwise). It will be apparent that many mechanisms for facilitating the purchase, or other acquisition, of content may be used.

According to various aspects of the invention, the service system may identify content in various ways. For example, in various implementations, the content may be identified or otherwise recognized by querying a database of content previously analyzed by the service system. In various implementations, broadcasters (e.g., radio stations, player partners, or others) may identify the content over a data channel, wherein the service may monitor the data channel, and may match the content by querying the database using fuzzy algorithms, or other techniques. In various implementations, the broadcaster (e.g., radio station) may be a partner of the service, and information about the content may be provided from the partner to the service. It will be apparent that various suitable mechanisms for identifying content may be used without departing from the scope of the invention.

According to various aspects of the invention, the service system may facilitate impulse advertisement interactions. For example, information about an advertisement played over a communication medium may be collected and the collected information may be sent to a user. Subsequently, the service system may receive a request to interact with the advertisement from the user, and the received request may be processed to facilitate the requested interaction. The information may be collected using various suitable techniques, including fuzzy matching algorithms, web scraping algorithms, or information provided over a data channel, among other techniques. Further, the collected information may include a tag line, a logo, text, an interaction mechanism, or an available action, among various other kinds of information. When a user interacts with the advertisement, processing the received request may including facilitating or otherwise taking one or more available actions associated with the advertisement.

Other objects and advantages of the invention will be apparent to those skilled in the art based on the following drawings and detailed description.

### BRIEF DESCRIPTION OF THE DRAWINGS

FIG. 1 illustrates an exemplary system for facilitating impulse content purchases according to various aspects of the invention.

FIG. 2a illustrates an exemplary method for facilitating impulse content purchases according to various aspects of the invention.

FIG. 2b illustrates an exemplary method for facilitating impulse advertisement interaction according to various aspects of the invention.

### DETAILED DESCRIPTION

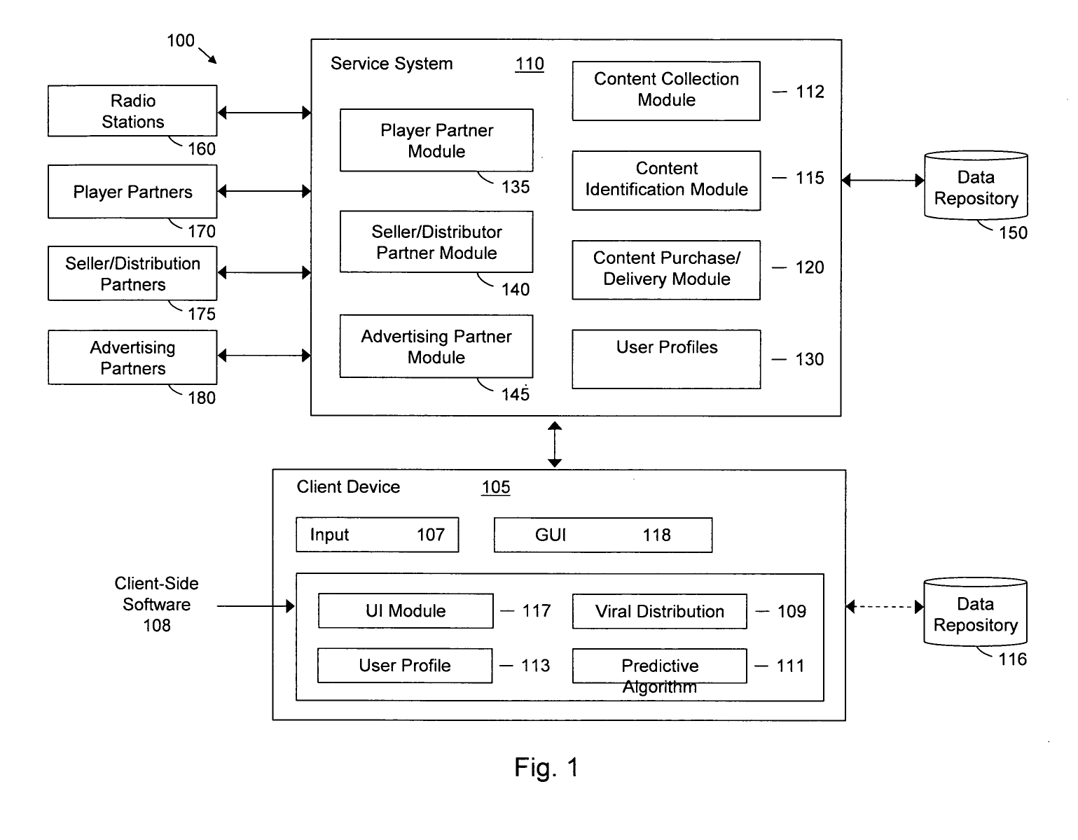

Referring to FIG. 1, an exemplary system 100 is illustrated according to various aspects of the invention. System 100 may include, among other things, a service system 110 communicatively coupled to at least one client communication device 105 (e.g., via a network, wireless access point, cellular communication, or otherwise, as will be apparent). Service system 110 may further include, among various other things, a content collection module 112, a content identification module 115, a content purchase/delivery module 120, user profile module 130, a player partner module 135, seller/distribution partner module 140, and an advertising partner module 145. Service system 110 may further interface with one or more content data repositories 150 (e.g., a database of song information, advertisements, profile information, or any other suitable data).

Content collection module 112 may collect content information from various sources, and may use the collected information to build and/or maintain a collection of content in data repository 150 (e.g., a played content database). Data repository 150 may be built manually, automatically, or a combination thereof, and may contain various databases (e.g., databases of played content for one or more radio stations 175, advertisements provided by an advertising partner 180, user profile information, or any other suitable data). Depending on various factors (e.g., a source, type, or other characteristic) of the collected content, the identification information or other information about the content stored in data repository 150 may vary. For example, information about music-related content (e.g., songs) stored in data repository 150 may include a song title, an artist, a genre, a radio station on which the song was played, a time at which the song was played, a duration, or all or part of the song's lyrics, among other things. Further, system administrators, clients, partners, or other entities may specify information needed to build data repository 150. For example, the specified information may include record information (e.g., frequency, name, tag line, location, etc.), scraping engine information (e.g., Uniform Resource Locators, song locations, artist name locations, etc.), or other information. As such, data repository 150 may store various kinds of information about content that may be used to subsequently resolve a user request (e.g., by identifying the content to provide information for a user to identify and/or purchase the content).

Content collection module 112 may monitor various sources to collect content information (e.g., information about songs, playlists, top lists, lyrics, advertisements, etc.). For example, content collection module 112 may monitor a broadcast of at least one radio station 175 to collect information about content being played at any given time. For example, content collection module 112 may monitor the broadcast of radio station 175 using a brute force technique, whereby a song or advertisement being broadcast may be intercepted or otherwise interpreted using any suitable mechanism (e.g., an AM/FM tuner, a built-in radio card, an Internet stream, etc.). A song recognition algorithm may recognize song information, advertisement information, or other content by querying a pre-processed content database (e.g., content or advertising information stored in data repository 150). In another example, content collection module 112 may monitor a radio data system, which may provide information about content (e.g., songs, advertisements, etc.) being played. For example, many radio stations 175 use radio data systems, or similar systems, which use a “ticker” to provide information about a song, artist, station, or other information about content being played at a given time. Similarly, many content players that broadcast over the Internet push song, artist, advertisement, or other information along with content being played. Accordingly, content collection module 112 may monitor radio data systems to extract information about played content using any of a number of suitable techniques (e.g., an RSS feed, an iTunes plug-in, etc.), and may store information about the content being played in data repository 150.

Content collection module 112 may also collect content information by a web scraping technique. For example, content collection module 112 may scrape an Internet site of a radio station 175 to retrieve playlists or other played content information. In another example, content collection module 112 may collect top list information (e.g., top singles charts, top album charts, etc.), lyrics, artists/song databases, etc. from various Internet sites or other network locations that include such information. In various implementations, service system 110 may partner with a player partner 170 or an advertising partner 180, among others. Player partner 170 or advertising partner 180 may be any entity that plays content, or otherwise controls information about played content (e.g., player partner 170 may control information about played songs or other media content, while advertising partner 180 may control information about played advertisements). It will be apparent, however, that player partner 170 and advertising partner 180 may be the same or different entities, in that suitable information about played content (e.g., including songs, advertisements, or other forms of content) may be provided by either or both of player partner 170 and advertising partner 180.

Player partner 170 may interface with service system 110 via player partner module 135, while advertising partner 180 may interface with service system 110 via an advertising partner module 145. As such, content collection module 112 may receive information about content (e.g., playlists, songs, advertisements, etc.) played by player partner 170 and/or advertising partner 180. For example, player partner module 135 may include various mechanisms for electronically transferring content information from a content player partner 170 (e.g., radio stations, satellite radio services, or other content players), while advertising partner module 145 may include various similar mechanisms for transferring advertising information. The transferred content information may include information that may be used to store information about played content in data repository 150. For example, the transferred content information may include identification information about music or songs (e.g., a song title), timing information (e.g., when content player partner 170 played the content), or various other kinds of information, as will be apparent. Further, the transferred content information may include identification information about advertisements (e.g., an advertisement tag line, images or logos, texts, mechanisms for interactions, actions associated with the interaction mechanisms, or any other suitable advertising information).

Content identification module 115 may identify content in response to user requests in various ways. For example, users may request content from service system 110 by specifying or otherwise identifying content, a radio station or other content player, or in various other ways, as will be apparent. Content identification module 115 may use various techniques, such as a fuzzy matching algorithm, to query data repository 150 for content corresponding to the requested content. For example, a user may be listening to a radio station 175, and in response to liking a song playing on radio station 175, may issue a request to service system 110 to purchase the content being played, or retrieve information about the content being played, among other things.

By collecting information about played content via content collection module 112 in real-time, service system 110 may also know what content the request relates to in real-time. For example, the collected content may be associated with timing information (e.g., a start time, an end time, a duration, etc.), which may be compared to timing information associated with the request to identify the requested content. In another example, a user may request content by providing full or partial information about the requested content (e.g., an artist name, a song name, etc.), and content identification module 115 may attempt to resolve the request in various ways. For example, content identification module 115 may query data repository 150 to search for the requested content, search various Internet sites or other locations for the requested content, or otherwise. For requests including partial information about the requested content, content identification module 115 may attempt to identify missing information by querying data repository 150, scraping third-party databases (e.g., an iTunes Music Store client), or in other ways. Accordingly, content identification module 115 may identify the content, resolve missing information, and/or determine additional fields needed to identify and/or resolve a request, among other things.

Content purchase/delivery module 120 may include various mechanisms for enabling a user to purchase, or otherwise acquire, desired content (e.g., songs). Moreover, content purchase/delivery module 120 may include various mechanisms for providing purchased content, further information about requested content, or other information to the user. Further, content purchase/delivery module 120 may enable users to interact with an advertisement provided to the client device, and may facilitate an interaction with the ad. For example, users may issue requests to service system 110, and content purchase/delivery module 120 may take further action (e.g., based on identification information generated by content identification module 115). For example, in various implementations, content identification module 115 may process a request having limited information about requested content by making a best effort to resolve the request (e.g., by identifying one or more potential matches for the request). Thus, content purchase/delivery module 120 may push a compiled/condensed version of the potential matches to client device 105 for a user to complete the request. For example, content purchase/delivery module 120 may push a list of top songs in response to a request for “Most Popular” music, a list of potentially matching artists in response to a song name, etc. In another example, a user request may be specific to a radio station 175, wherein client device 105 may have an option for a user to request information from service system 110 about content currently being played. In yet another example, a user may select an advertisement or otherwise issue a request relating to an advertisement (e.g., go to a web page, dial a telephone number), and content purchase/delivery module 120 may deliver information to client device 105 or otherwise facilitate an action (e.g., when using a mobile phone to make a request to dial a phone number associated with an advertisement, content purchase/delivery module 120 may push appropriate data to client device 105 to dial the phone number).

Further, content purchase/delivery module 120 may provide various options for a user to purchase, or otherwise acquire, the identified content. For example, a user may specify, or user profile module 130 may indicate, that a specific user desires to automatically purchase requested content, wherein content purchase/delivery module 120 may automatically process a sale for the requested content in such cases. In another example, a user may specify, or user profile module 130 may indicate, that the user desires to have an e-mail reminder sent to the user's mailbox to purchase the content later. For example, the email-reminder may include a link to a seller/distribution partner 160 (e.g., a download service, such as iTunes™, or similar service), and seller/distribution partner 160 may process the sale when the user follows the link. In yet another example, service system 110 may include mechanisms for users to purchase, or otherwise acquire, the content directly from service system 110. Thus, content purchase/delivery module 120 may also process sales automatically, in response to purchase requests, or by sending an e-mail reminder, or using other techniques, as will be apparent. In another example, content purchase/delivery module 120 may route a purchase request to content seller/distributor partner 160 via seller/distributor partner module 140, wherein seller/distribution partner 160 may handle billing and delivery of purchased content for the user. Moreover, content seller/distributor partner module 140 may include a tracking mechanism for tracking customer purchases routed through service system 110. Accordingly, service system 110 may receive a portion of revenue from a transaction facilitated between seller/distribution partner 160 and various users. In a similar respect, content purchase/delivery module 120 may track advertisement interactions routed through service system 110. As such, advertising partners 180 may use advertising partner module 145 to provide advertisements or advertisement information, audit advertising consumption, reimburse service system 110, or otherwise, as will be apparent.

Customer profile module 130 may include various kinds of information for profiling customers. For example, customer profile module 130 may include a profile for each customer, wherein a profile may include an identifier for a customer, contact information for the customer, information about the customer's client device 105, billing information for the customer (e.g. credit card or other payment information), and/or historical and/or real-time transaction (e.g., a purchase history, advertisement interactions, etc.). For example, customer profile module 130 may indicate whether various users prefer to process content transactions automatically, via e-mail reminders, on-the-fly, or in other ways. Accordingly, customer profile module 130 may include any suitable customer information, and service system 110 may manage interactions with various users based, at least in part, on user profile information 130.

Client device 105 may include, among other things, an input mechanism 107, a graphical user interface 118, and/or client side software 108. Client side software 108 may be downloaded to, or otherwise stored and/or installed on client device 105, using any suitable mechanism, as would be apparent to those skilled in the art. In some implementations, client device 105 may be a mobile device (e.g., cell phone, handheld, mp3 player, satellite radio interface, etc.), and accordingly, client side software 108 may facilitate impulse content purchases in an anywhere, anytime virtual point-of-sale. In some implementations, client device 105 may also be a desktop device (e.g., personal computer, etc.), and client side software 108 may still provide flexible impulse content purchases, even though an “anywhere” virtual point-of-sale may not necessarily exist.

Client side software 108 may include, among other things, a user interface module 117, a predictive algorithm module 111, a user profile 113, a viral distribution module 109, and/or a local memory and/or database 116. Client side software 108 may enable a user to specify as little information as possible in a request, while still generating enough information to allow service system 110 to understand the request.

Input 107 may be any suitable input mechanism for providing data to client device 105. For example, input 107 may be a numerical and/or text-based keypad, a microphone, a radio card, an AM/FM tuner, etc. For example, a user may be listening to a radio station 175 via a satellite input, AM/FM tuner, or the like, where content broadcasted by radio station 175 may be received by input 107 and provided to client side software 108. Accordingly, client side software 108 may attempt to identify information about the content (e.g., by querying local database 116, extracting information from a radio data system feed, etc.), and the identified information may be provided to user interface module 117.

User interface module 117 may be configured to display a radio-like digital display via graphical user interface 118. For example, a frequency, station name, or other user interface elements may be displayed, along with one or more options to submit requests relating to content being played. In some implementations, the displayed information may be based on information retrieved via a data channel (i.e., client side software 108 knows the radio station 175 precisely). In some implementations, the displayed information may be based on a predetermined set of radio stations 175 for a given location. For example, client device 105 may be a location-based device (e.g., personal navigation device, global positioning system device, etc.), wherein service system 110 may provide the predetermined radio stations to client device 105 based on a location of client device 105 at a given time. In another example, user profile 113 and/or user profile module 130 may indicate a default location for a user, or the user may change a location, and the predetermined radio stations may be updated accordingly.

User interface module 116 may be configured to display various options for a user to request content being played on a given radio station 175. For example, the user may request content by selecting one of the displayed set of radio stations, based on a data feed, using a free-form text input to specify the content and/or radio station, or in other ways. As such, various mechanisms may enable a user to request content by full or partial information about the content (e.g., radio station, artist, song name, lyrics, top lists, or various combinations thereof).

In some implementations, users may enter requests using a free-form text input 107, such as a telephone keypad, QWERTY keyboard, or other mechanism. User interface module 117 may be configured to display various fillable fields, wherein predictive text algorithm 111 may include a domain specific text-prediction technique to assist free-form inputs. For instance, database 116 may include domain-specific information for various fields, such that a user may key in a few letters of an artist's name, and predictive text algorithm 111 may use dynamic programming techniques to predict the artist's complete name. Thus, predictive text algorithm 111 may account for limitations of input devices 107, such as by using a modified, domain-specific, version of T9 predictive text protocol that accounts for telephone keypad letter layouts. Thus, users may locate the artist's name without having to press a key multiple times to input a second or third letter on the key. Further, predictive text algorithm 111 may improve upon well-known T9 algorithms by using a dynamic domain-specific recognition technique that also accounts for potential spelling errors (e.g., word prediction may vary depending on whether a user is inputting an artist, song title, etc.).

Moreover, predictive text algorithm 111 may populate one or more additional fields based on an input to a first field (i.e., the additional fields may be auto-refreshed based on information in another field). Thus, once an artist has been selected, a list of songs may be automatically displayed based on the selected artist. Such interdependencies may based entirely on information contained in database 116, or when memory constraints do not permit (e.g., in an embedded device), some or all of the information may be fed to client device 105 from data repository 150 (i.e., via a link to service system 110), and the fed information may be cached at client device 105 for subsequent use.

User interface module 117 may also enable a user to request content based on predetermined categories. For example, the user may select a United States Top 10 list, Billboard Top 10 list, Most Popular content list, or any other suitable category, and the user may select content from the lists. Furthermore, client device 105 may link to service system 110, such that service system 110 may periodically send updates to client device 105 as changes to the lists occur.

User profile 113 may include various user settings or other information about a user of client device 105. For example, user profile 113 may include the user's most recent location, historical requests, e-mail address, a device identifier, alternative device identifiers, or any other information about the user. Client side software 108 may also include a heuristic algorithm, or other “learning” algorithms, to build and refine user profile 113 over time. Accordingly, in some implementations, the information contained in user profile 113 may be used by predictive text algorithm 111 when populating various fields. For example, a user may frequently issue requests about a particular artist, such that predictive text algorithm 111 may disambiguate a first artist from a second artist based on the frequent request information in the profile.

Viral distribution module 109 may include features enabling a user to share client software 108 with others. For example, a user may select a referral button, or other user interface element, which may send service system 110 a name, email address, and/or other information about another individual that service system 110 should “invite.” In some implementations, one or more devices may support inter-device communication (e.g., via a short message service), which may handle transferring referrals to the referred individual. Viral distribution module 109 may enable unregistered users to use service system 110. That is, any user may download client software 108, receive it from another other (e.g., via a peer-to-peer mechanism), and users do not necessarily have to register to enable service system 110. For example, an unregistered user may request content from service system 110, and the unregistered user may be directed to a seller/distribution partner 160 with which the user is registered, or otherwise has a relationship, to purchase the content. Nonetheless, the unregistered user may still exploit various customization features by way of user profile module 113, such that client software 108 may gradually “learn” the user. The user profile 113 may be maintained in a separate configuration file on client device 105, optionally insulated from service system 110. Accordingly, users may avoid typical concerns regarding privacy and security of another service provider.

As described above, service system 110 and client communication device 105 may communicate via any suitable communication mechanisms, as would be apparent to those skilled in the art. For example, in various implementations, service system 110 and client device 105 may interact when users submit requests to service system 110 (e.g., over a network, a wireless connection, or otherwise). Users may enter information into one or more fields, click a “Submit” button, or other interface element, and an XML, HTTP, or similar type of request may be sent to service system 110 with the relevant information. Service system 110 may take various steps towards resolving the request, or advancing towards resolving the request, such as identifying the requested content, providing purchase options, processing a purchase, or sending e-mail reminders of the identified content and how to purchase it, among other things.

In various implementations, service system 110 and client device 105 may interact when service system 110 sends updates, such as updates to database 116, version updates for software 108, or other updates. Service system 110 may provide updates to client device 105 in response to pings sent from client device 105 to service system 110. The pings may be sent periodically (e.g., at predetermined intervals, at user initiation, etc.), wherein service system 110 may determine whether any updates have occurred to any relevant databases (e.g., an update to lists of stations and/or locations in data repository 150). The pings may be sent to service system 110 using a protocol that allows client device 105 to identify a current version of software 108, a current list of databases, a current version of the listed databases, or other information. In response to the pings, service system 110 may initiate an update to client software 108 upon receiving user confirmation. Further, service system 110 may initiate an update to database 116, wherein the update may be incremental (e.g., only provide new information, such as a synchronizing update) or a replacement (e.g., replace an entire database 116 with a new database 116). The protocol may also respond to the pings based on settings internal to service system 110, such as when a Uniform Resource Locator for a server associated with service system 110 changes. As such, service system 110 may continually update information stored in client device 105 as the service expands, or changes in other ways.

In various implementations, service system 110 and client device 105 may interact when a client-based database 116 is impractical. For example, while client-based database 116 may make a user experience as seamless as possible by minimizing server interaction, some devices (e.g., embedded devices, such as mobile telephones) often have significant memory constraints, such that housing database 116 may interfere with optimal use of device 105. In such cases, such as on a Web client, client device 105 and service system 110 may interact during a session to populate various lists on-the-fly (e.g. a list of songs for a chosen artist may be provided during the session).

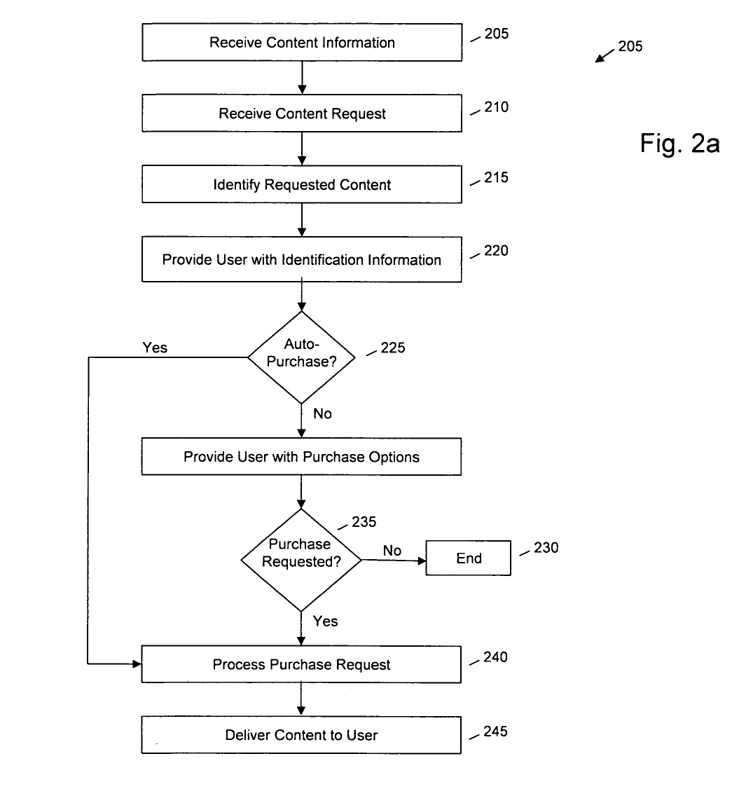

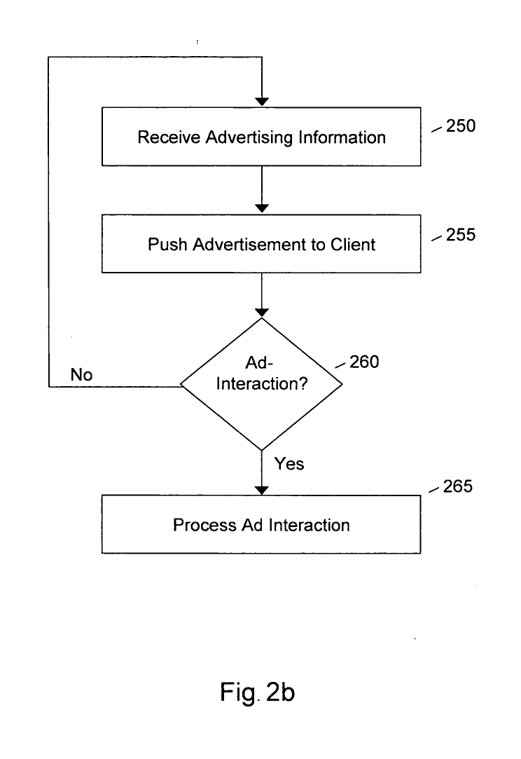

According to various aspects of the invention, as shown in FIG. 2a, for example, an exemplary method 200 may be used to facilitate impulse content purchases. Method 200 may begin in an operation 205, where a service system collects information about content in various ways to build and/or maintain a content data repository. For example, the service system may collect content information from radio station broadcasts, radio data systems, Internet streams, web scraping, content player partners, or in other ways. Accordingly, the service system may build a repository of content, including time associations between played content and various content players, or other content information.

The service system may provide client software (e.g., a plug-in, thin application, etc.), and a user may use the software to request content in an operation 210. For example, the user may request content heard and/or seen on a radio, television, or other communication medium, or the user may request content based on a desired artist, song, album, or other criteria. The request may be made using any suitable communication device, over any communication channel, using any communication protocol. For example, the communication device can be a mobile device (e.g., cell phone, personal digital assistant, or other communication device). The communication channel can be any wired or wireless channel, including a public switched telephone network, a cellular network, a broadband network, or any other communication channel (or combination thereof) that enables communication with the service system. The communication protocol can be a telephone call, a text message, short message service, multimedia message service, instant message, or other protocol. The request may include content player information (e.g., a radio station on which a song was played), timing information (e.g., when the song was played), customer information (e.g., based on a telephone number, an identifier associated a client device, or otherwise). For example, the content player information may include a name and/or frequency of the radio station, a city (or other location) in which the song was played, or other information.

Upon receipt of the request, the service system may identify the requested content in an operation 215. The service system may identify the content in real-time, based on timing information, through web scraping, or in other ways. For example, various techniques which may be used to identify the requested content are described in greater detail above with reference to content identification module 115. After the service system identifies the requested content, or retrieves more information about the requested content, the identification information may be provided to the user in an operation 220.

In an operation 225, the service system may optionally determine, based on user profile information (e.g., stored in a user profile module), whether to automatically execute a purchase transaction for the requested content on behalf of the user. For example, a user profile may specify to automatically execute purchases in various circumstances. When the profile indicates that an automatic purchase is in order, processing may proceed to an operation 240 for processing the purchase (described in greater detail below). When the user profile does not indicate that the purchase should be automatically executed, processing may proceed to an operation 230, where various options may be provided for a user to purchase, or otherwise acquire, the requested content. For example, in some implementations, when the content can be unambiguously identified, an option may be provided for the user to confirm whether or not to execute the purchase. In some implementations, the user may alternatively elect to have an e-mail reminder sent to the user's mailbox, where the e-mail may include an identification of the song and information about how to execute the purchase (e.g., a link to a content store or other transaction system). As such, when the user issues a purchase request in an operation 235, processing may proceed to operation 240 for processing the purchase request. However, when the user does not issue such a request, the method may end.

In operation 240, the user's request to purchase content may be handled in various ways. For example, the service system may include various billing mechanisms for the user to complete the purchase, or the service system may redirect the user to a seller/distribution partner for purchasing the content. In another example, an e-mail reminder may be sent to the user's mailbox, wherein the e-mail reminder may direct the user to the service system and/or the seller/distribution partner for the user to subsequently complete the purchase at their convenience.

Furthermore, the service system may include various features for maximizing value of content purchases. For example, content-based businesses (e.g., iTunes or other content delivery entities) generate revenue through a combination of customers paying for content (e.g., subscription-based, per-copy, etc.) and/or advertisement revenues. Radio and television stations often contribute to sales for such content-based businesses, as radio and television stations market various types of content. However, not only do the stations not receive a direct share of revenues generated by content-based businesses, but the stations actually pay for played content. Accordingly, the service system may directly link a purchase and a marketer of the purchase (e.g., a station on which a purchaser heard the song, and thus an initiator of the purchase). Thus, a revenue-share model may be provided that accounts for various entities responsible for a purchase, which may benefit various entities in a value-chain, including a manufacturer (e.g., an artist, production company, etc.), a distributor (e.g., content storefront), a reseller (e.g., the service system), a marketer (e.g., a radio, television, or other station), and/or others.

Once a user has completed the content purchase, the purchased content may be delivered to the user in an operation 245. For example, the content may be delivered to one or more destinations, as specified by the user (e.g., an mp3-enabled cell phone, a desktop iTunes, an email box, etc.). Information regarding the purchase and delivery may be stored in a user profile, sent with a request (e.g., automatically and/or manually from a client device), in response to a prompt associated with a response by the service system to the user device, or in other ways. When the request comes from a cellular phone or other device which can be automatically identified, the identification information (e.g., a device identifier) may be used to effectuate delivery. In some implementations, an e-mail may be sent with instructions about how to later download the purchased content. Other delivery mechanisms will be apparent to those skilled in the art.

Referring to FIG. 2b, an exemplary method for facilitating impulse advertisement interaction is illustrated according to various aspects of the invention. The method shown in FIG. 2b may begin in an operation 250, where a service system or other suitable system may receive advertisement information. For example, the advertisement information may be provided by an advertising partner, a player partner, or otherwise, as will be apparent. Further, the advertisement information may be identified automatically, such as by using a scraping algorithm, a data monitoring service, or other suitable technique. In various implementations, advertisements being played (e.g., on a radio station, a satellite radio service, or other suitable medium) may be monitored or otherwise identified, and information about the advertisement may be stored for subsequent use.

For example, in an operation 255, advertisement information may be pushed or otherwise provided to a client using any appropriate technique (e.g., push technology, a data stream, or otherwise). The advertisement may be provided to a user based on an advertisement being played on a radio station that a user is listening to, randomly or based on a predetermined algorithm (e.g., a demographic profile, location information, etc.), based on a song being played (e.g., an advertisement to purchase a ringtone corresponding to the song), or using various other techniques, as will be apparent. Various kinds of information about the advertisement may be provided to the client. For example, the information may include a tag line associated with the advertisement, text, buttons, or other mechanisms for interacting with the advertisement, logos, images, or other graphical information, available actions (e.g., call a given number, open a web page, etc.).

Subsequently, a decisional operation 260 may determine whether a user has requested or otherwise interacted with the advertisement. When the user has not interacted with the advertisement, the method may return to operation 250 to continue collecting advertising information. Decisional operation may poll the client, or otherwise wait for a predetermined amount of time before repeating the process and providing a new advertisement in a subsequent operation 255. When the user selects, requests, or otherwise interacts with the advertisement, however, an operation 265 may include processing the advertisement and/or the associated action. For example, when the user interacts with the advertisement, appropriate action may be taken (e.g., by directing a client browser to a web site, dialing a telephone number, or otherwise processing an action associated with the advertisement). Furthermore, processing the advertisement action in operation 265 may include building user profile information (e.g., demographics associated with the user taking action), tracking consumption information (e.g., a click-through rate), invoking appropriate billing systems (e.g., billing an advertiser, reimbursing a player partner, or otherwise managing revenue associated with the advertisement interaction). As such, using the systems and methods of the invention, users may be provided with information to facilitate impulse interactions with various kinds of content (e.g., songs, music, advertisements, etc.).

Implementations of the invention may be made in hardware, firmware, software, or any combination thereof. The invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described in the above disclosure in terms of specific exemplary aspects and implementations of the invention, and performing certain actions. However, those skilled in the art will recognize that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it is understood that it is within the knowledge of one skilled in the art to effect such feature, structure, or characteristic in connection with other aspects or implementations whether or not explicitly described. Thus, various changes and modifications may be made, without departing from the scope and spirit of the invention. The specification and drawings are to be regarded as exemplary only, and the scope of the invention is to be determined solely by the appended claims.

What is claimed is:

1. A method for facilitating impulse content transactions, comprising:
collecting information about content played over a communication medium, the collected information including identification information associated with the played content;
storing the collected information in a data repository;
receiving a request for content from a user;
identifying content associated with the received request; and
providing information about the identified content and/or at least one option for purchasing the identified content to the user.

2. The method of claim 1, wherein the information is collected using at least one of a fuzzy matching algorithm, a web scraping algorithm, or information provided over a data channel.

3. The method of claim 1, wherein the identification information includes at least one of a station, a time, an artist, or a song title associated with the played content.

4. The method of claim 1, wherein the request includes an identification of at least one of a station or a time associated with the requested content.

5. The method of claim 1, wherein the request includes partial information about the requested content, and wherein identifying the requested content includes determining information needed to resolve the request.

6. The method of claim 4, wherein providing the user information about the identified content includes providing the user options for resolving the request.

7. The method of claim 1, further comprising:
receiving a purchase request for the identified content from the user; and
facilitating a transaction for the identified content.

8. The method of claim 6, further comprising tracking the facilitated transaction.

9. The method of claim 6, wherein facilitating the transaction includes directing the user to a distributor of the identified content.

10. The method of claim 6, wherein facilitating the transaction includes sending an electronic message to the user, the message including instructions for subsequently completing the transaction.

11. The method of claim 6, wherein facilitating the transaction includes completing a purchase for the identified content, the method further comprising:
delivering the purchased content to the user.

12. The method of claim 10, wherein delivering the purchased content to the user includes sending the purchased content to a device associated with the user.

13. The method of claim 10, wherein delivering the purchased content to the user includes sending an electronic message to the user, the message including instructions for the user to subsequently retrieve the purchased content.

14. A method for facilitating impulse advertisement interactions, comprising:
collecting information about an advertisement played over a communication medium;
sending the collected information to a user;
receiving a request to interact with the advertisement from the user; and
processing the received request to facilitate the requested interaction.

15. The method of claim 14, wherein the information is collected using at least one of fuzzy matching algorithm, a web scraping algorithm, or information provided over a data channel.

16. The method of claim 14, wherein the collected information includes at least one of a tag line, a logo, text, an interaction mechanism, or an available action.

17. The method of claim 16, wherein processing the received request includes facilitating the available action.
